(19) United States
(12) Patent Application Publication
(10) Pub. No.: US 2009/0080323 A1
(43) Pub. Date: Mar. 26, 2009

(54) Device and Method for Obtaining a Substrate Structured on Micrometric or Nanometric Scale

(76) Inventors: Massimiliano Cavallini, Vergato (IT); Gianluca Massaccesi, Casalecchio Di Reno (IT); Francesco Cino Matacotta, Bologna (IT); Fabio Biscarini, Bologna (IT)

Correspondence Address: Modiano & Associati;Via Meravigil 16, 20123 Milan, Italy, IT

(21) Appl. No.: 12/226,923

(22) PCT Filed: May 4, 2007
(86) PCT No.: PCT/IT2007/000331

§ 371 Date: Oct. 31, 2008

(30) Foreign Application Priority Data
May 9, 2006 (IT) BO2006A000340

(51) Int. Cl. G11B 3/70; B29C 59/02; B32B 3/00

(52) U.S. Cl. 369/272.1; 264/293; 264/104; 428/195.1; 40/299.01; G9B/3.103

(57) ABSTRACT

A method for providing a locally rough surface which is spatially structured on micrometric and/or nanometric scale and is formed by a substrate, so as to obtain a product. The method comprises the steps of flattening and/or smoothing the rough substrate in preset regions.

The present invention relates to a device and a method for obtaining a morphology spatially structured on micrometric and nanometric scale, formed by motifs and/or structures of micrometric and/or nanometric dimensions, formed on a substrate, as a consequence of a molding process.

Some of the possible fields of application are for example: optical devices, information storage devices, including labels containing a high density of information, sensors and others.

### BACKGROUND OF THE INVENTION

Currently, many micro- and nanomanufacturing processes are based on molding the surface of the material.

Many industrial manufacturing processes with submicrometric or nanometric treatments use lithography based on photons, electrons or other particles (typically ions).

One of the crucial steps in lithography entails depositing a thin film on a substrate and generating a contact mask thereat, so that in subsequent processes the template of the mask can be transferred onto the substrate by removing the material of which the substrate is made or by depositing another material.

The thin film must have limited surface roughness, in order to prevent scattering of the incident ray, with consequent loss of spatial resolution.

A typical, known process of lithography in submicrometric or nanometric work for producing details consists in depositing a low-roughness film on a medium and subsequently exposing the film, with the corresponding medium, to a beam of high-energy particles such as electrons, photons or ions, optionally through a mask which is provided with a selected template.

Other types of lithography are based on the use of particle beams.

Such particle beam changes the chemical structure of the exposed region of the film and leaves unchanged the unexposed region.

By immersing the substrate and the film in a developer, the region of film that has been exposed to the energy beam, or alternatively the portion that has not been exposed, is removed, obtaining a film which reproduces the template, or the corresponding negative, traced in such mask.

The printing resolution that can be obtained in lithographic processes is limited by the wavelength of the particles used to etch the film, by the properties of said film and by the developing process.

Lithographic methods based on beams of ions or electrons allow a high spatial resolution (tens of nanometers) but are serial methods, i.e., the motifs are written one by one by means of the beam of particles or photons.

These techniques are limited by the scanning rate of the beam of particles and accordingly are scarcely suitable both for large-scale processing and for mass production and in any case require a developing step.

In order to obviate the cited drawbacks, alternative lithographic techniques have been developed which have the requirement of being parallel and at the same time allow to manufacture details of submicrometric and nanometric dimensions on films simply and at low cost.

An example is given in U.S. Pat. No. 5,772,905 by S. Y. Chou, which discloses and proposes a lithographic method which combines conventional lithographic technologies with the less expensive method, already known with resolutions on the order of one millimeter, of pressure imprinting (imprinting), providing imprintings on nanometric or sub-micrometric scales (nanoimprinting) of thermoplastic polymers.

Such US patent discloses a low-cost but high-resolution lithographic approach which abandons the use of energy beams or particle beams.

Such nanoimprinting entails placing an appropriately contoured mold on a polymeric film which is arranged on a rigid medium and applying pressure, optionally accompanied by suitable heating of the medium.

The imprinting generates on the film a series of parts in relief and recesses which correspond to the respective recesses and parts in relief of the mold.

In nanoimprinting, the roughness of the film affects the resolution that can be obtained with this method. An evolution of such nanoimprinting, disclosed for example in U.S. Pat. No. 6,518,189 by S. Y. Chou, entails that as a consequence of the molding of the polymer the portions of film at the recesses are removed by subsequent developing, obtaining on the substrate a film template which matches the recesses of the mold.

A further evolution of nanoimprinting, disclosed for example in U.S. Pat. No. 6,818,139 by H. H. Lee, provides for the preliminary treatment of the polymer with a solvent in order to make the layer of polymer easier to imprint.

A further evolution of nanoimprinting, disclosed for example in US patent application 20040192041 by J.-H. Jeong, provides for treatment with ultraviolet rays during the imprinting step. This irradiation can either be extended to the entire region being imprinted or localized spatially.

A possible alternative to nanoimprinting, disclosed for example in U.S. Pat. No. 6,342,178 by M. Yasuhiko, relates to the replica molding process. In the replica process, a solution in which a polymer or other material has been dissolved is deposited onto a mold, and once the evaporation of the solvent has ended the polymer cures and assumes the shape of the mold.

Other patents related to micrometric or nanometric scale manufacturing, for example U.S. Pat. No. 6,375,870 (N. J. Visovsky et al.), entail providing on a medium a thin film which is morphologically structured, by molding the nanometric motifs on a substrate with known replica molding methods.

Other processes, such as for example the one disclosed in international patent application PCT WO 2005078521 by M. Cavallini et al., provide for molding a film of a mixture obtained by dispersing a material in the medium, which is for example polymeric, obtaining by subsequent developing a chemical structure which is spatially defined on a microscale and/or nanoscale.

The greatest disadvantages and drawbacks of the known solutions mentioned in the cited patents are due to the need to perform a developing step after the imprinting step. Such developing step entails at least one additional process step and requires the use of chemical reagents and/or irradiation systems.

Another disadvantage of known solutions mentioned in the cited patents relates to the processes themselves, since nanostructured motifs must be etched into the mold itself.

### SUMMARY OF THE INVENTION

The aim of the present invention is to overcome the drawbacks of the background art cited above.

An object is to obtain a spatially structured model or pattern of nanometric and micrometric size on the surface of a substrate, characterized in that it is obtained according to the method described hereinafter.

Another object is to obtain a memory element which can be read optically on a substrate, characterized in that it is obtained according to the described method, said substrate being defined by a material having optical and/or spectroscopic properties.

All the cited methods for industrial manufacture with submicrometric or nanometric processes provide devices and/or articles by direct manufacturing or molding of the motifs and use thin films with low surface roughness.

According to the present invention, a manufacturing method is provided to obtain a product which is defined by rough motifs of nanometric and micrometric size on the surface of a substrate, characterized in that it comprises reducing the roughness of the surface of said substrate in definite regions of said substrate.

The present invention relates to a device and a method for providing a structured molding or pattern on a medium in a manner described as indirect, and in particular a method for providing a surface whose morphology is spatially structured on a micrometric and nanometric scale and which is defined by motifs and/or structures of micrometric and/or nanometric size, formed on a rough substrate as a consequence of a process for smoothing or flattening regions of the substrate.

The device consists of the molded substrate which contains spatially structured regions with different roughnesses. Said device, for example, lit with white and/or colored and/or ultraviolet and/or grazing light exhibits an optically detectable contrast. Such contrast can be attributed to the different roughness and can be either optically positive (rougher regions appear lighter than the others) or optically negative (rougher regions appear darker than the others). The type of contrast depends on how the device is lit (for example grazing light instead of light from above).

Contrast also can be detected with any technique which is sensitive to surface roughness variation, either by measuring chemical and/or physical properties directly correlated to roughness (for example a measurement, with any technique, of the area per unit surface) and by measuring properties which are indirectly correlated (for example a change in color caused by optical and/or diffraction phenomena).

The term “roughness” as used here references the property of the surface of a body, constituted by geometric micro- and nanoimperfections which are normally present on the surface or are also the result of mechanical processes; these imperfections generally have the appearance of grooves, scratches or bumps which have a variable or oriented shape, depth and direction.

The measurement of roughness, expressed in microns or nanometers, is the average value of the variations of the actual profile of the surface with respect to the average height of such surface. This measurement refers to a base length of the profile being analyzed in order to avoid the influence of other types of unevenness.

Depending on the chemical and/or physical properties of the material, such device can therefore be an electronic component (for example by using a substrate material which is a conductor, an electrode), an electro-optical component (for example by using a substrate material which is electro-active with spectroscopic properties), an optical memory element (for example by using a substrate material which has optical and/or spectroscopic properties), a magnetic memory element (for example by using a substrate material which has magnetic properties) or another device.

Advantageously, the nano- and/or microstructuring of the products of the process according to the present invention is the one that is naturally or artificially present on the surface of the substrate, differently from what occurs for example in the patents of the background art cited above.

The technical features of the invention, according to the above aim and objects, are clearly observable from the content of the appended claims, and its advantages will become better apparent in the detailed description that follows, given with reference to the accompanying drawings and photographs, which illustrate preferred and merely exemplifying embodiments thereof, wherein:

### BRIEF DESCRIPTION OF THE DRAWINGS

FIGS. 1a, 1b, and 1c show, in a schematic enlarged-scale side view, a sequence of operations for molding the surface of a naturally rough material by pressure imprinting according to the invention;

FIG. 1d is a schematic enlarged-scale side view of a portion of the corresponding device;

FIGS. 2a, 2b and 2c are schematic enlarged-scale side views of a sequence of operations for molding the surface of a material which is initially molded artificially by pressure imprinting;

FIG. 2d is a schematic enlarged-scale side view of a portion of the corresponding device;

FIG. 3 is a view of an example of a device which is formed by an interdigitated structure, which is obtained by smoothing a rough substrate. In this example, the rougher regions appear white. In this example, optical contrast is detected by means of an optical microscope obtained by lighting the device with grazing light;

FIG. 4 illustrates the example of a device which is formed by a series of squares arranged on a surface. The device is obtained by smoothing a rough substrate except in the light regions. In this example, optical contrast is detected by means of an optical microscope obtained by lighting the device with grazing light;

FIG. 5 shows, in a further enlarged scale, the detail of FIG. 4. In this case, it can be seen that the surface roughness is greater at the square structures. This roughness is determined by a series of parallel lines which are spaced by 1.5 micrometers and are 250 nanometers deep;

FIG. 6 is an atomic force microscope image, illustrating the topographic effect of morphological flattening;

FIG. 7 illustrates the example of a device formed by a series of four squares arranged on a surface. The device is obtained by smoothing a rough substrate except in the dark regions. In this example, optical contrast is detected by means of an optical microscope obtained by lighting the device with normal light;

FIG. 8 is an atomic force microscope image of a thin polymeric film on which a holographic grating is imprinted;

FIG. 9 is an atomic force microscope image of a thin polymeric film on which a holographic grating is imprinted and on which a motif is imprinted, with the method according to the invention, whose characteristic dimension is much larger than the periodicity of the holographic grating and which bears binary information;

FIG. 10 is the atomic force microscope image of a mold (obtained by means of photolithographic techniques on a silicon plate) used for morphological flattening of a holographic grating. The motifs of the mold are constituted by squares with a side length of 20 microns and a depth of 1.5 μm;

FIG. 11 is a view of a label with digital information stored according to Aztec encoding (a matrix of 151×151 dots with a central bull's-eye with three frames, check bits along its two directions, and various other characteristics specified by the standard);

FIG. 12 is a view of a label with digital information stored according to Aztec encoding, obtained according to the present invention and termed En-Code™ label, constituted by a film of polypropylene-Al-polypropylene multilayer measuring 15×10 mm and 80 microns thick.

### DESCRIPTION OF THE PREFERRED EMBODIMENTS

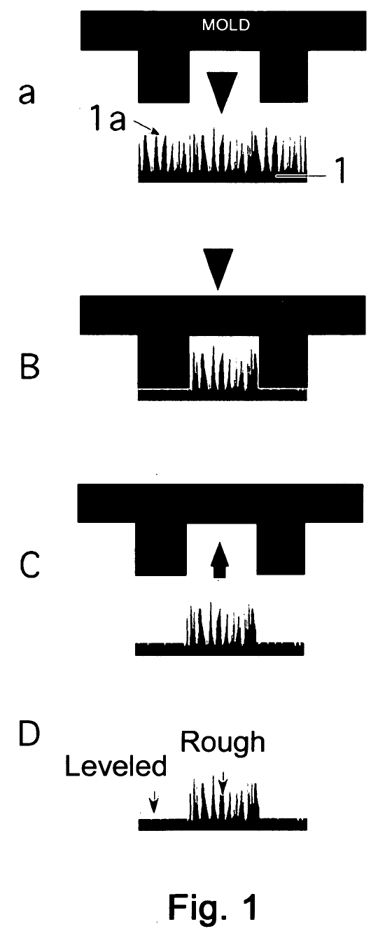

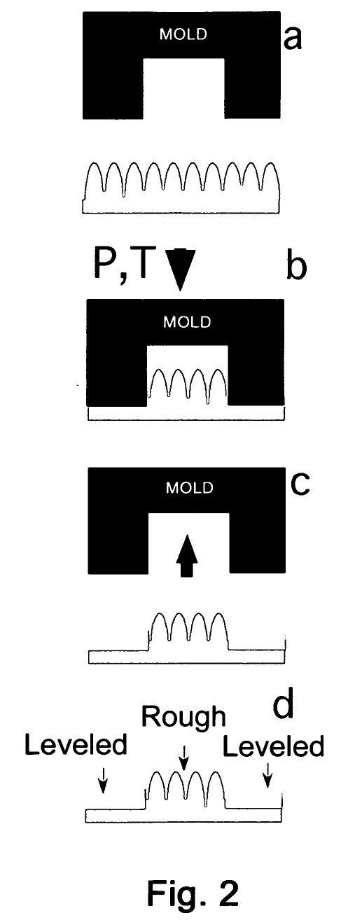

In accordance with the accompanying drawings, with particular reference to FIGS. 1 and 2, the reference numeral 1 designates the substrate and the reference numeral 1a designates a surface thereof; a morphology is formed on the surface 1a. Such morphology can also be constituted on a thin film placed on a medium, which can be of the same kind as said medium or of a different kind.

In the continuation of the present description, merely by way of example, reference will be made, without thereby losing generality, to a substrate 1 which is formed by a polymer, particularly polycarbonate.

This material is taken as an example to describe the method, but such method can be applied to a wide range of materials and substrates, including biological molecules such as for example biopolymers, proteins and the like, copolymers, molecular materials, metals, semiconductors, composites, alloys or other materials; likewise, reference will be made to micrometric and nanometric spatial scales, since this is the field of greatest interest in the application of the described method, which however remains valid and effective also for larger dimensions.

With particular reference to FIGS. 1a,b,c and 2a,b,c, the method uses a material which has a surface roughness and is intended to form the device. Such surface roughness can be the natural roughness of the surface of the substrate (example of FIG. 1) and can be morphologically random (see FIG. 6) or artificial or obtained in a highly controlled manner by means of any industrial process, including molding processes (example of FIG. 2).

Such surfaces formed with artificial roughness can also be constituted by ordered gratings with particular optical properties, including diffraction gratings and/or holographic gratings.

Subsequently, the surface of the medium is molded by smoothing and/or flattening portions of such surface.

According to what is shown in FIGS. 1a, 1b, 1c, 2a, 2b and 2c, the surface of the substrate can be subjected to pressure molding with a mold and/or to pressure molding assisted by a thermal treatment and/or to pressure molding assisted by a chemical treatment and/or to compressive molding assisted by irradiation with ions and/or photons and/or local physical treatments and/or local chemical treatments.

The range of pressures, temperatures, treatment times and any use of other chemical and/or physical agents depends on the nature of the material being molded. Merely by way of non-limiting example, the pressures applied during the process can vary in a range from 1 N/cm² to 100 MN/cm². The temperature range is from 10 to 5000° K.

In all the cited cases, these methods are known in the molding, for example, of polymers and therefore are referenced exclusively for comprehension of the text, since they are applied to the substrate as if it were a polymer.

With particular reference to FIGS. 1a, 1b, 1c, 2a, 2b and 2c, in order to provide pressure imprinting, a mold is structured in such a manner that the motifs of interest are provided as recesses of the mold, etched into the (flat) surface of the mold. Such mold is placed in contact with the substrate and is pressed onto it so that the portions in relief flatten and/or smooth the corresponding portions of the surface of the substrate; this imprinting process can be performed after heating the substrate and/or after chemical treatment and/or after physical treatment and/or after irradiation with ions and/or photons.

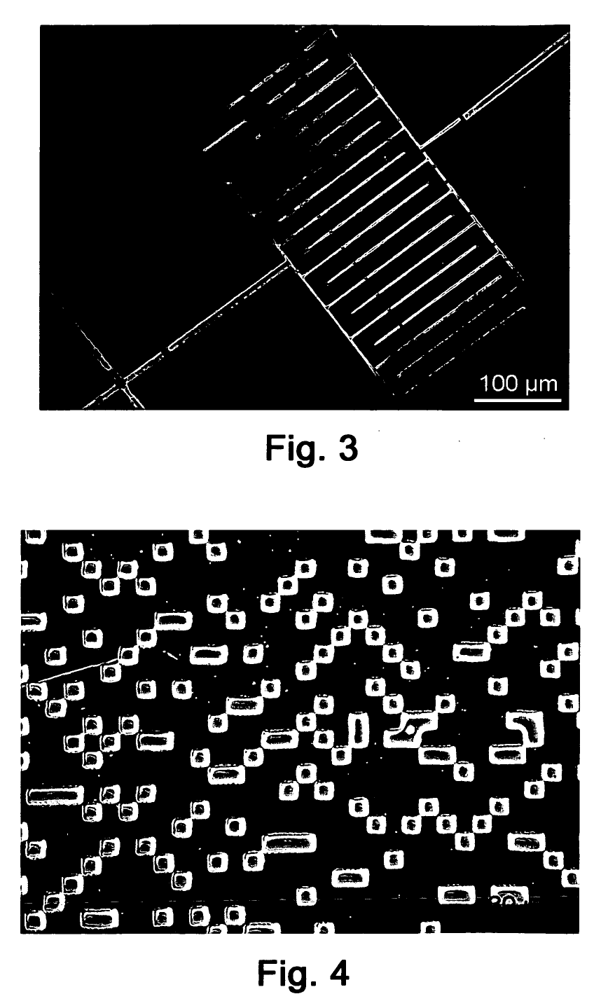

FIG. 3 shows the example of a device which is formed by an interdigitated structure which is obtained by smoothing a rough substrate except in the light regions. In this case, optical contrast is detected by means of an optical microscope obtained by lighting the device with grazing light.

FIG. 4 shows the example of a device which is formed by a series of squares arranged on a surface. The device is obtained by smoothing a rough substrate except in the light regions. In this example, optical contrast is detected by means of an optical microscope obtained by lighting the device with grazing light. This example constitutes a memory element in which the bits are constituted by the molded squares.

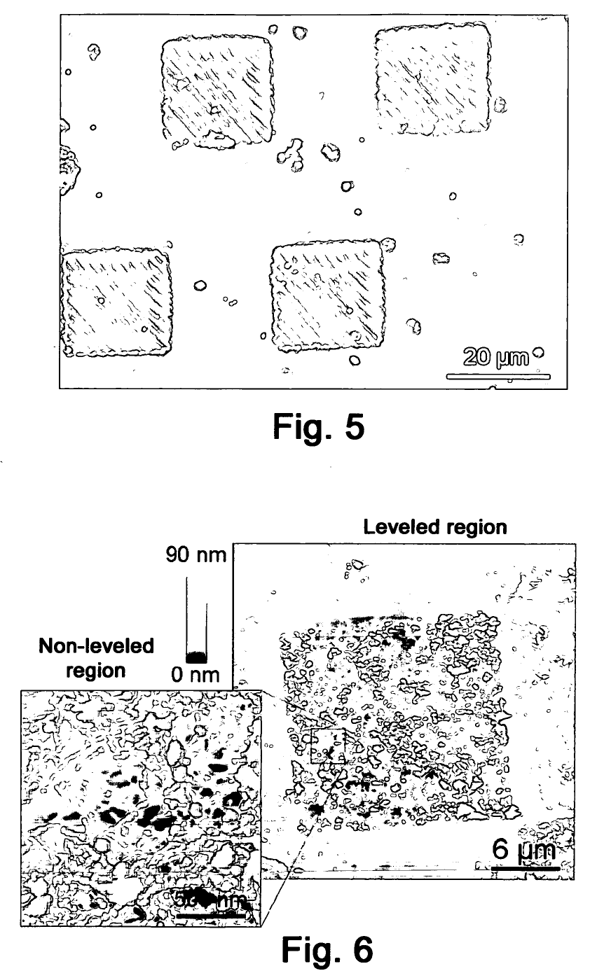

FIG. 5 shows, in further enlarged scale, the detail of FIG. 4.

In this case, the artificial surface roughness, constituted by parallel lines which are spaced by 1.5 micrometers and are 250 nanometers deep, is visible. Such roughness is therefore greater at the square structures.

FIG. 6 shows an atomic force microscope image showing the topographic effect of morphological flattening on a surface which is naturally (randomly) rough.

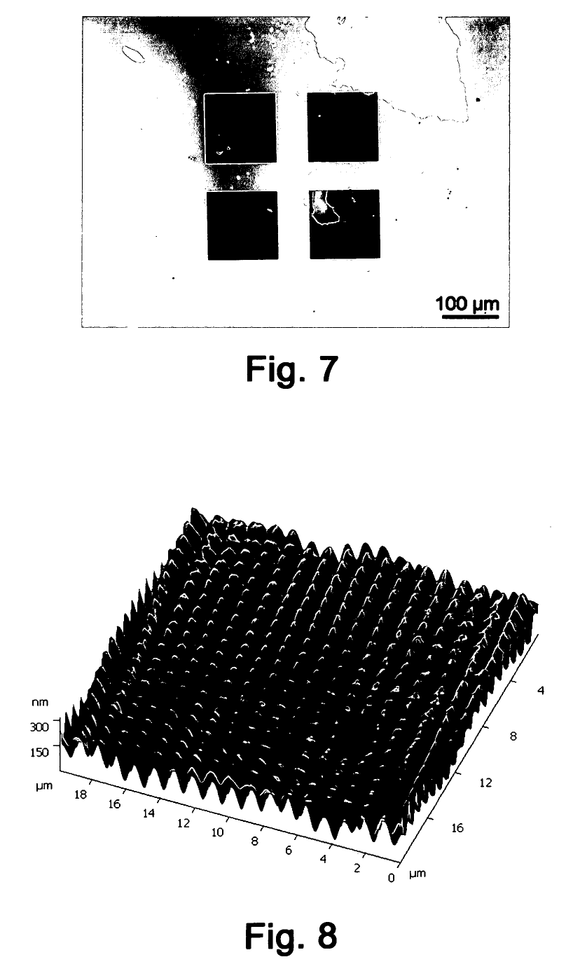

FIG. 7 shows the example of a device which is formed by a series of squares arranged on a surface. The device is obtained by smoothing a rough substrate except in the dark regions. In this example, optical contrast is detected by means of an optical microscope obtained by lighting the device with normal light.

Advantageously, the step for molding the surface can occur in any way, for example also by simple etching or any method which produces flattening of the morphology on the surface.

With particular reference to FIGS. 3, 4, 5 and 7, it is noted that sharp contrast is observed at the rough parts with respect to the smooth parts when they are lit with grazing light.

This contrast defines, in the particular case, a possible permanent memory element.

In general, therefore, a method is defined for organizing in a spatially controlled manner, on a submicrometric and/or nanometric scale, a substrate so that the morphological properties of the material of which the substrate is made define the characteristics of the product obtained with such method.

The spatially controlled distribution of the structures is in itself a useful product, such as for example a high-density memory element which can be read optically, or a label.

The reduction in roughness induces a different behavior which is spatially distributed on the surface of the substrate as regards the intensity and conditions of the phenomenon of light reflection and absorption.

This difference in optical behavior produces an optical contrast which can even be very sharp between the regions with reduced roughness and the regions with unmodified roughness. This contrast allows to read patterns which are imprinted with the method according to the present invention with optical readers.

The roughness of the substrates can be both the natural surface roughness of the substrate (which generally has a random appearance) or can be a roughness which is generated specifically with different imprinting and/or etching methods for several purposes. The requirement for providing sharp optical contrast between regions with unmodified roughness and regions with reduced roughness is that the horizontal extension of the oscillations of the value of the height of the surface of the substrate with respect to the average height of said surface must be much lower than the horizontal extension of the typical dimension of the pattern that one wishes to imprint.

For example, when the ratio between the lateral dimension of the surface micro-bumps and the dimension of the structures is smaller than 1 (one).

Specifically, for a square pattern with a side measuring 20 microns, the lateral dimension of the surface micro-bumps can be less than 2 microns.

For the sake of simplicity, reference is made in the present description to this method, which is a preferred embodiment of the present invention and is known as “inverse embossing”.

### 1 Provision of a Contrast Pattern

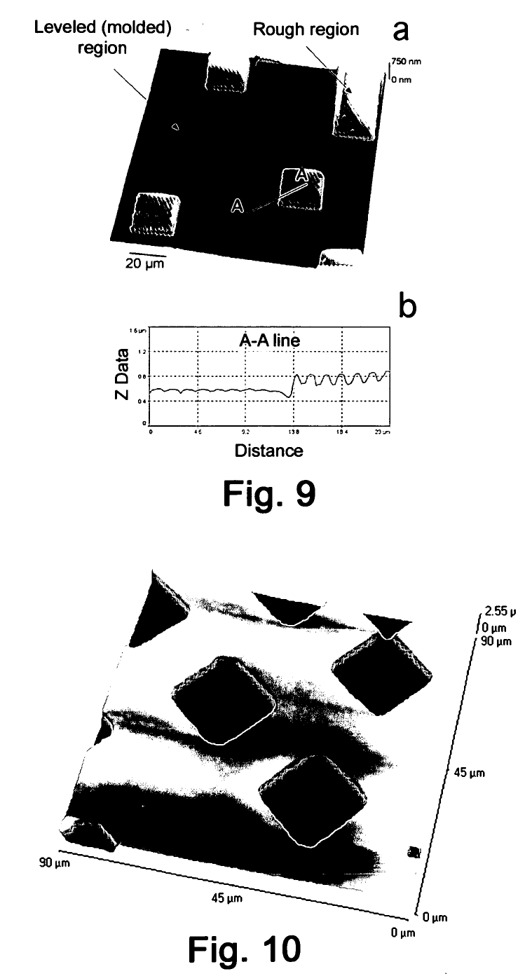

An example of product provided according to this method is a small film (with sides measuring from fractions of a millimeter to a few centimeters) formed with thin polymeric film on which a holographic grating has already been imprinted with any known method, such holographic grating being characterized by one- or two-dimensional periodic variations of the height of the surface (FIG. 8), and on which a pattern is imprinted according to one of the teachings given in the present description, the motif dimensions of which are much larger, for example on the order of magnitude or more, than the periodicity of the holographic grating, and bearing binary information which is encoded according to the alternation of regions with modified roughness and regions with reduced roughness. FIG. 9 shows an example which is obtained by imprinting by inverse embossing a pattern constituted by squares measuring 20 microns on each side (binary value 1) (depth 300 nanometers).

The mold (see FIG. 10) is constituted by squares with a side measuring 20 microns and with a depth of 1.5 μm. By compressing with the mold the patterned surface of the polyacetate polymer (applying in this particular case a pressure of 10 KN/cm² at the temperature of 80° C. for 300 seconds), the regions in contact with the non-etched regions of the mold are flattened with respect to the regions that have been in contact with the recessed regions of the mold (as shown in FIG. 9). This flattening of the grooves produces a high suppression of light diffraction (interference among the various rays reflected by the grooves) where the grooves are flattened.

FIGS. 4 and 5 show the reduced brightness of the regions where roughness caused by holographic grooves has been suppressed selectively. The pattern of colored bright squares, recordable with any digital optical reader, stands out on the dark background caused by the compression of the holographic grating and the consequent reduction of the diffracted light.

### 2. Materials

It is possible to use all materials having a natural roughness of more than 10 nm and/or on which it is possible to imprint advantageously a pattern: for example, most mono- and multilayer polymeric films, advantageously including multilayer films which contain a metallic reflective film and polymeric films which contain a holographic grating.

### 3. Pattern Encoding

Merely by way of example, in order to allow easy decoding of the binary information contained in a succession of regions having a different optical contrast, it has been selected to adapt an encoding standard which is known and used extensively to provide dot matrix, which is known as Aztec. Of course, any form of information encoding which produces a succession of “light” and “dark” regions, which are to be matched with the binary values, is perfectly suitable for the provision of the labels described here.

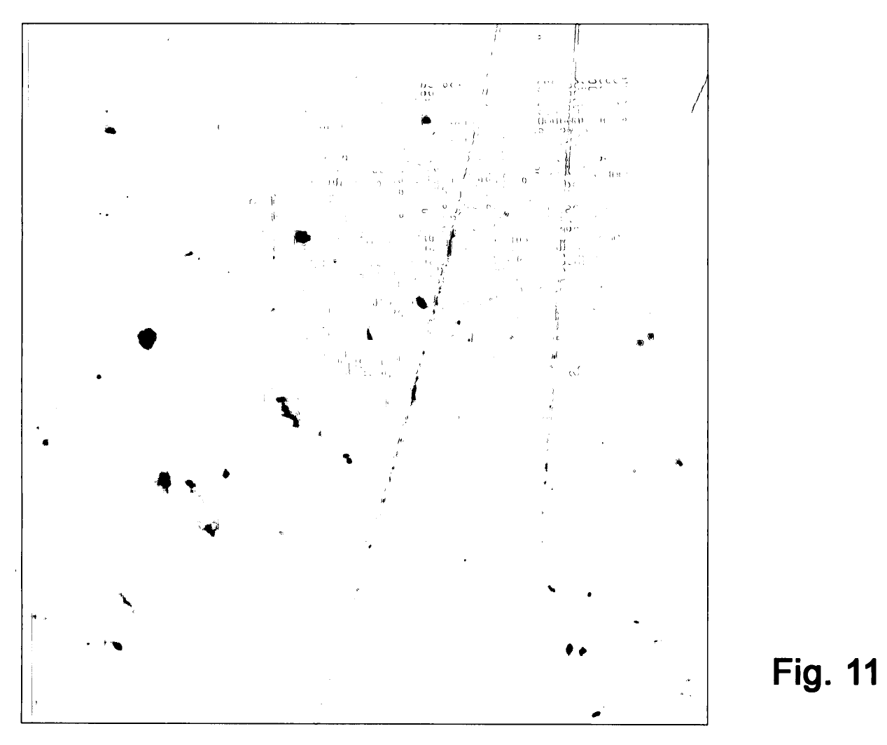

The label shown in FIG. 11 bears a pattern according to the Aztec encoding (a matrix of 151×151 dots with a central bull's eye with three frames, check bits along the two directions, and various other characteristics which are cited by the standard).

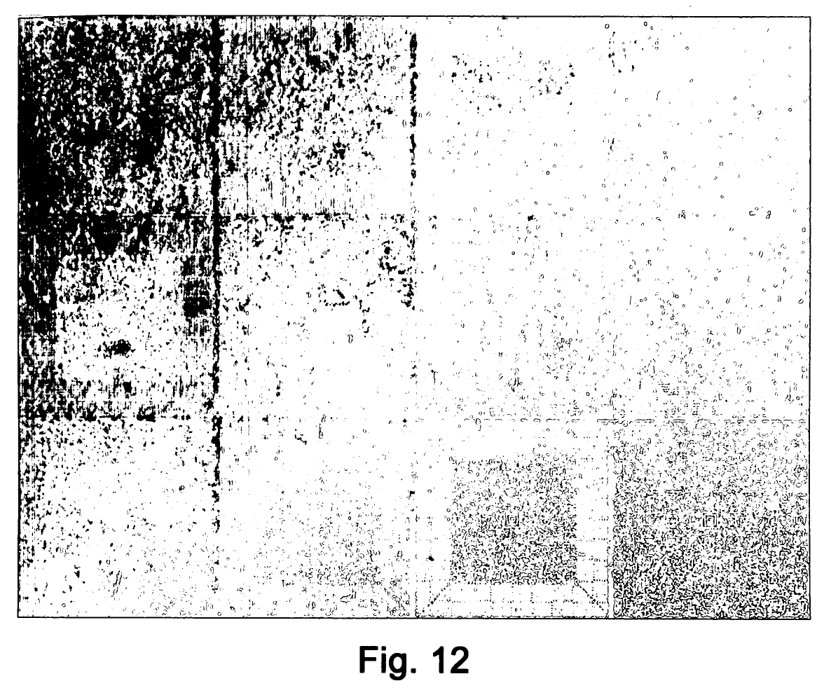

4. En-Code™ Label The embodiment of a label obtained according to the present invention and known as En-Code™ label is constituted by a film of polypropylene-Al-polypropylene multilayer which measures 15×10 millimeters and has a thickness of 80 microns. A uniform one-dimension holographic relief is imprinted on a face of said film by means of known methods and is constituted by parallel grooves which have a depth of approximately 250 nm and are mutually spaced by 1 micron. With a subsequent imprinting step, performed with inverse imprinting techniques, portions of the holographic relief are flattened selectively with a mold (flat if made of silicon or cylindrical if made of nickel). Such mold bears in relief patterns which correspond to dot matrix modules according to the Aztec standard of 151×151 bits, each bit having a square shape and sides 20 microns long. Each Aztec module therefore measures 3.02×3.02 mm and bears information equal to 2850 bytes. It is possible to provide on each En-Code™ label 1 to 12 Aztec modules (FIG. 12), with digital information stored up to 34.20 KB, equal to a density of 22.8 KB/cm².

Advantageously, the proposed method can also be used with organic, inorganic or biological media.

This method can also be used with any type of material and medium in order to obtain other devices without losing generality.

The present invention also relates to:
an optically readable rewritable or non-rewritable memory element which is obtained by molding a substrate formed by a material which has optical properties in a logic pattern.
a magnetically readable rewritable or non-rewritable memory element, obtained with the method cited above, obtained by molding a substrate which is formed by a material which has magnetic properties in a logic pattern.
a spatially structured pattern, which is obtained by molding a substrate which is formed by a material having chemical and/or physical properties which depend on the roughness of the surface.

The invention achieves the intended aim and objects, and in particular this method allows to manufacture directly motifs in a substrate without having to resort to lithographic processes.

This method utilizes in a new manner the process of smoothing and flattening protrusions provided on a surface.

The method as described works on a micrometric and nanometric scale and is fully within the field of micro- and nanotechnologies.

The invention thus conceived is susceptible of evident industrial application; it can also be the subject of numerous modifications and variations, all of which are within the scope of the inventive concept; all the details may further be replaced with technically equivalent elements.

The disclosures in Italian Patent Application no. BO2006A000340, from which this application claims priority, are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-31. (canceled)

32. A manufacturing method for obtaining a product which is defined by rough motifs of nanometric and micrometric size on the surface of a substrate having an initial roughness, comprising locally reducing said initial roughness of the surface of said substrate in definite regions of said substrate by heating said substrate and pressure imprinting said substrate having an initial roughness with a mold having a flat surface provided with portions in relief and with recesses, said recesses corresponding to said rough motifs, by contacting said mold with said substrate and pressing said mold onto said substrate, so that the portions in relief flatten corresponding regions on said surface of said substrate to obtain said definite regions with reduced roughness and regions of said substrate having the initial roughness corresponding to the recessed portions of the mold, and defining said rough motifs on the surface of said substrate.

33. The method according to claim 32, wherein said substrate comprises a polymer or a polymeric mixture.

34. The method according to claim 33, wherein said polymer or mixture of polymers comprises polycarbonate.

35. The method according to claim 31, wherein the material of the substrate is selected from the group formed by soluble polymers or precursors capable of polymerization during imprinting (for example polyaniline, polyphenylene vinylene, poly-(3-alkyl-thienyl).

36. The method according to claim 31, wherein said substrate comprises a copolymer.

37. The method according to claim 31, wherein said substrate comprises a mixture of one or more polymers with other materials.

38. The method according to claim 31, wherein said substrate comprises a molecular material.

39. The method according to claim 31, wherein said substrate comprises biological molecules.

40. The method according to claim 31, wherein said substrate comprises a gel.

41. The method according to claim 31, wherein said substrate is organic.

42. The method according to claim 31, wherein said substrate is biological.

43. The method according to claim 31, wherein said substrate is formed by an inorganic material.

44. The method according to claim 31, wherein said substrate having an initial roughness to be contacted with the mold is morphologically structured in a controlled manner.

45. The method according to claim 44, wherein said substrate has a morphology which defines a pattern with regularly spaced or pseudo-random features.

46. The method according to claim 45, wherein said substrate has a morphology which defines a holographic grating.

47. The method according to claim 31, wherein said substrate is formed by a conducting material and the resulting product is an electronic device, since it is a conductor.

48. The method according to claim 31, wherein said substrate is formed by a semiconductor material and the resulting product is an electronic or optoelectronic device.

49. A spatially structured template or pattern, obtained according to the method described in claim 31, said pattern being formed on the substrate.

50. A label bearing binary information, comprising a substrate which has a surface provided with a pattern formed by rough motifs alternated with regions having a reduced roughness with respect to said rough motifs, obtainable with the method according to claim 31 said binary information being defined according to the alternation of said rough motifs and of said regions with reduced roughness.

51. The label according to claim 50, wherein said substrate is provided by a monolayer or multilayer polymeric film, said multilayer polymeric film optionally comprising a metallic film.

52. The label according to claim 50, wherein said substrate has a morphology which defines a holographic grating or a pattern with features spatially controlled on the sub-micrometer and micrometer length scale.

53. An optically readable memory article, obtained according to the method described in claim 31, said substrate being formed by a material having optical and/or spectroscopic properties.

54. The optically readable memory article according to claim 53, wherein it is rewritable.

55. A magnetically readable memory article, obtained according to the method described in claim 31, said substrate being formed by a magnetic material.

56. The magnetically readable memory article according to claim 54, wherein said substrate is formed by a ferromagnetic material.

57. An electrode, obtained according to the method described in claim 31, said substrate being formed by a conducting material.

58. An electrode, obtained according to the method described in claim 31, said substrate being formed by a semiconductor material.

59. An electrode, obtained according to the method described in claim 31, said substrate being formed by a metallic conducting material.

60. A method for obtaining a product with a surface which has a predetermined distribution of alternating regions of said surface, said alternating regions having different optical or magnetic or electrical or chemical and/or physical properties, comprising the steps of:
providing a surface of said product having a morphology that defines a holographic grating with a given initial roughness having micrometric or nanometric dimensions, and
reducing said initial roughness in selected regions of said surface, thus forming alternated regions of said surface with said initial roughness and with a roughness which is reduced with respect to said initial roughness, said alternating regions having surfaces with micrometric or nanometric dimensions.

61. A label bearing binary information, comprising a substrate which has a surface provided with a pattern formed by rough motifs alternated with regions having a reduced roughness with respect to said rough motifs, obtainable with the method according to claim 60, said binary information being defined according to the alternation of said rough motifs and of said regions with reduced roughness on said holographic grating.

62. The label according to claim 61, wherein said holographic grating has a periodicity and said motifs have dimensions one order of magnitude or more larger than said periodicity of the holographic grating.
